(19) United States
(12) Patent Application Publication
(10) Pub. No.: US 2020/0372894 A1
(43) Pub. Date: Nov. 26, 2020

(54) HYBRID AUDIO NOISE CANCELLATION SYSTEM

(71) Applicant: Intel Corporation, Santa Clara, CA (US)

(72) Inventors: Tongyan Zhai, Sacramento, CA (US); Shantanu D. Kulkarni, Hillsboro, CA (US); Srikanth Potluri, Sacramento, CA (US)

(21) Appl. No.: 16/774,927

(22) Filed: Jan. 28, 2020

(51) Int. Cl. G10K 11/178; H04R 1/40; H04R 1/10; H04R 3/00; G06N 3/04

(52) U.S. Cl. CPC G10K 11/17873; H04R 1/406; H04R 1/1041; G10K 2210/3038; G06N 3/04; G10K 2210/1081; H04R 2420/07; H04R 3/005

(57) ABSTRACT

The present disclosure includes a computing device comprising one or more processors, a non-transitory machine-readable medium storing a program executable by the one or more processors, the program comprising sets of instructions for: receiving an audio signal from a microphone on the computing device, receiving the audio signal from an external device coupled to the computing device, and cancelling, by the computing device, noise in the audio signal.

### BACKGROUND

The present disclosure pertains to audio systems, and more specifically, to hybrid audio noise cancellation.

Modern computer systems typically have a variety of mechanisms for receiving and producing audio signals. For example, audio signals may be received and/or transmitted between a computer and a variety of wearable systems such as headsets, for example. Typically, the computer uses only one of the many audio streams for performing various audio processing functions.

For example, noise cancellation in a headset is sometimes implemented by sensing the speaker and the ambient audio air signals, and performing the noise cancellation in the headset before playing it back to the user. However, such systems can require costly and/or heavy additional circuitry, which may also increase power consumption.

More generally, it would be advantageous to use more of the available audio resources available on modern computers to improve audio signal processing.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates using multiple audio streams on a computing device according to an embodiment.

FIG. 2 illustrates performing an audio function according to an embodiment.

FIG. 3 is an example of noise cancellation according to an embodiment.

FIG. 4 is an example method of performing noise cancellation according to an embodiment.

FIG. 5 illustrates an example computing device including audio processing according to various embodiments.

FIG. 6 illustrates hardware and software for performing audio processing according to an embodiment.

FIG. 7 illustrates hardware and software for performing audio processing according to another embodiment.

FIG. 8 illustrates an example method for performing audio processing according to another embodiment.

FIG. 9 illustrates hardware of a special purpose computing machine configured according to the above disclosure.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

Features and advantages of the present disclosure include using multiple audio streams for performing audio processing functions on a variety of different processors. The techniques disclosed herein are applicable to a wide range of audio processing functions. One advantageous example application of the present techniques is noise cancellation.

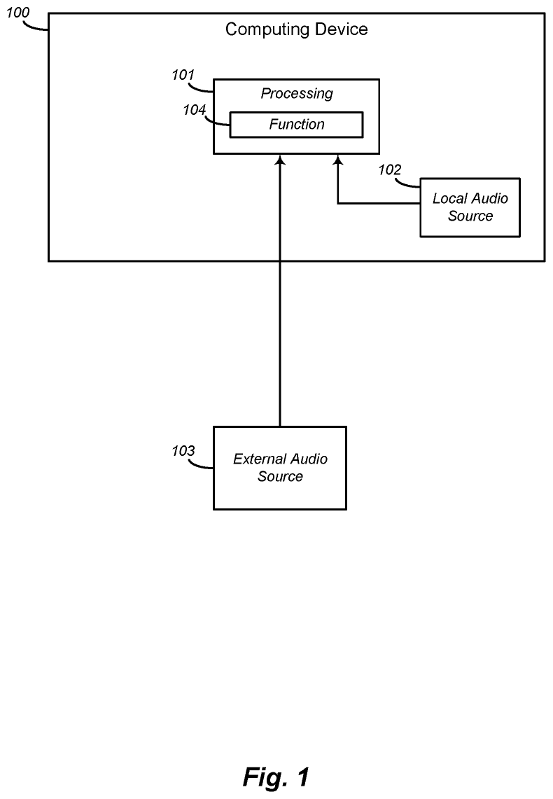

FIG. 1 illustrates using multiple audio streams on a computing device according to an embodiment. As illustrated in FIG. 1, a computing device may have a number of available audio streams. For instance, computing device 100 may include one or more local audio sources 102 and one or more external audio sources 103. Local audio sources may include one or more local microphones, for example. External sources may include one or more external microphones, for example. In various embodiments, audio signals having substantially the same content may be received as multiple independent audio streams in computing device 100. Processing audio streams having substantially the same content, such as the same audio speech signals and/or same ambient noise may allow for more efficient processing of the audio signals. Accordingly, as illustrated in FIG. 1, multiple audio signals from different sources (e.g., microphones) are provided for processing 101. Processing 101 may include some audio processing function, such as noise cancellation as described in more detail below, for example. Advantageously, simultaneous receipt and processing of the same audio received on different microphones, for example, may be performed on a variety of different processors, such as a digital signal processor (DSP), microprocessor (e.g., an x86 or ARM based central processing unit (CPU)), or a neural network processor (e.g., a Gaussian Neural Network Accelerator or “GNA”), for example. For a DSP, the audio signals are processed using hardware circuits in the DSP (e.g., digital filters and the like). For a CPU or GNA the audio signals may be processed using software algorithms as audio processing objects, for example. In various embodiments, any one or more of a CPU, a neural network processor (e.g., a GNA) and/or a DSP, for example, may be on the same integrated circuit.

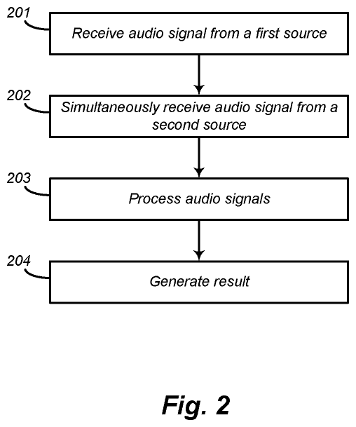

FIG. 2 illustrates performing an audio function according to an embodiment. At 201, an audio signal is received from a first source, such as a microphone. At 202, the audio signal is received simultaneously (or nearly simultaneously) from a second source, such as an external microphone. As described in more detail below, it may be desirable to synchronize the two audio signals prior to processing. At 203, the audio signal is processed (e.g., by a DSP, CPU, or GNA). At 204, audio signal processing results are generated.

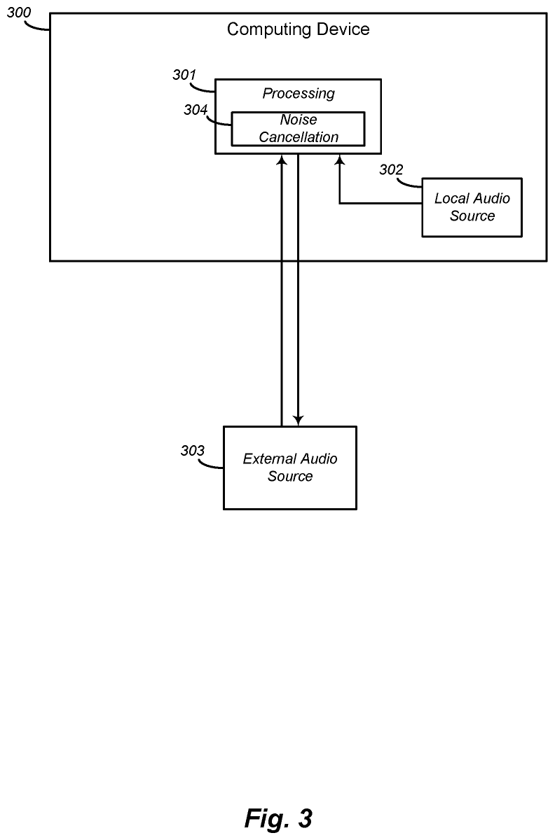

FIG. 3 is an example of audio signal processing according to an embodiment. The present architecture may be advantageously used to improve noise cancellation, for example. As illustrated in FIG. 3, a local audio source 302, such as a local microphone, may generate an audio signal, and an external audio source 303, such as an external microphone, generate the same audio signal. Accordingly, the audio signal may be received at the same time (or nearly the same time) at processing component 301. In this example, processing 301 includes noise cancellation 304. In this example, ambient audio may be received and transmitted to processing 301 from a local microphone and an external microphone (e.g., a headset or earpiece). The ambient noise may be spatially separated by the distance between the two microphones and more effectively cancelled, for example, by noise cancellation function 304.

For example, in an office environment during conference calls (e.g., software conferencing meetings (e.g., Skype, WebEx), customer support calls etc., users typically use an external headset over USB or Bluetooth with a laptop/notebook for the audio communication. In some cases, when there are multiple audio communications happening in the same area, the audio communication of a neighboring person can be easily heard and sneak into the on-going communication. This unintended audio from nearby speakers and the other surrounding noise disturb the on-going communication. This ambient noise impacts the work productivity and also creates confidential/security issues. The present architecture may be used to solve this example problem by combining and processing audio inputs from the external headset microphone and the computer microphone. Accordingly, noise cancellation may be implemented based on the two spatially diverse microphones inputs, for example, to cancel the surrounding noise without altering the design of the computing device itself.

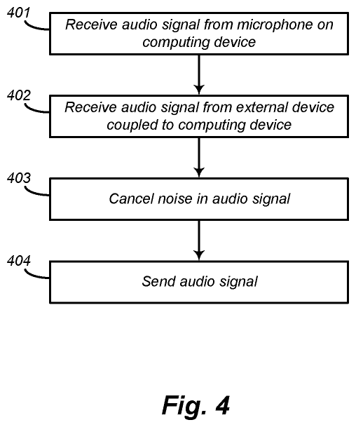

FIG. 4 is an example method of performing noise cancellation according to an embodiment. At 401, an audio signal is received from a microphone on a computing device. At 402, the audio signal, which may have the same audio content separated by the spatial positions of an external microphone, is received from an external device couple to the computing device. At 403, noise is canceled in the audio signal. At 404, the audio signal, with noise cancelled, is sent from the computing device. In one embodiment, the audio signal may be sent to the external device, which may be a headset. In another embodiment, the audio signal is sent to one or more other computers (e.g., over a network during a call or conference call).

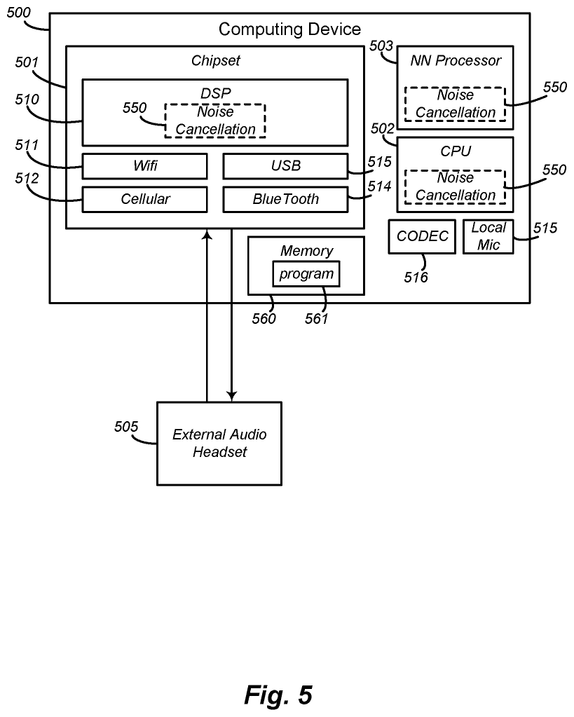

FIG. 5 illustrates an example computing device including audio processing according to various embodiments. As mentioned above, various embodiments of the present disclosure may perform audio processing functions using different components of a computing device. In this example, a computing device includes a DSP, CPU, and neural network processor, but in other embodiments a computing device may have fewer than all of these components or only one of these components, for example. The present example is illustrative of the various locations where noise cancellation may occur.

For example, computing device 500 may include a CPU 502, NN processor 503, chipset 501, local microphone (“mic”) 515, and coder/decoder (“CODEC”) 516. Chipset 501 may include, for example, circuits for a DSP 510, high speed wireless networking (e.g., 802.11xx or “WiFi”) 511, wireless connectivity (e.g., Bluetooth) 515, Cellular 512, or one or more wired connections (e.g., USB) 514. An external audio headset, for example, may connect to the computer using a wired or wireless connection through one of the chipset components (e.g., Bluetooth or USB). Local mic 515 may be a digital or analog microphone, for example. In one embodiment, local mic 515 is an analog microphone having an output coupled to CODEC 516, and CODEC 516 may provide a local audio signal, for example. In another embodiment, local mic 515 is a digital microphone having a digital output for carrying the local audio signal, for example. In various alternative embodiments, noise cancellation 550 may be implemented in hardware in the DSP 510 or in software in the CPU 502 or NN processor 503. As mentioned above, NN processor 503 and/or DSP 510 may be included on the same integrated circuit as CPU 502, for example. While DSP 510 is considered a hardware implementation, it is to be understood the DSP, CPU, and NN processor(s) implement their functions, to varying degrees, based on a program 561 stored in a non-transitory machine-readable medium (e.g., memory 560). Such a program 561 is executable by the one or more processors and includes sets of instructions for configuring the DSP, CPU, or NN processor to perform their functions, for example.

In various embodiments, computing device 500 may be a notebook (aka laptop) computer, a tablet computer (e.g., an iPad, Kindle, or Nook), or a mobile communications computer (e.g., a handheld phone, smart watch, etc. . . . ). It is to be understood that such devices may include one or more microphone that may be placed at various locations on the computing device. External audio may be received from an external headset, earpiece, or other devices that provide a second microphone with spatial diversity from the microphone on the computing device, for example. Additionally, in one embodiment, microphone 515 may be an omni-directional microphone. Further, in some embodiments, a microphone on an external device may be a directional microphone, for example.

Features and advantages of the present disclosure may combine audio inputs from the local microphone and the microphone on the external headset to improve the quality of the up-stream audio. Therefore, instead of running the noise cancellation algorithm in the external headset, it may be implemented in the computing device itself, where the intended audio signal (e.g., the voice of the person with headset) is separated from the surrounding noises (e.g., including voices from other people) and enhanced to achieve premium audio quality. The ambient microphone(s) signal in the computing device 500 can be routed directly to the chipset or through optional external audio CODEC 516 (e.g., through a Soundwire or High Definition Audio interface). The voice data from external headset may be routed either through USB interface or through a Bluetooth interface.

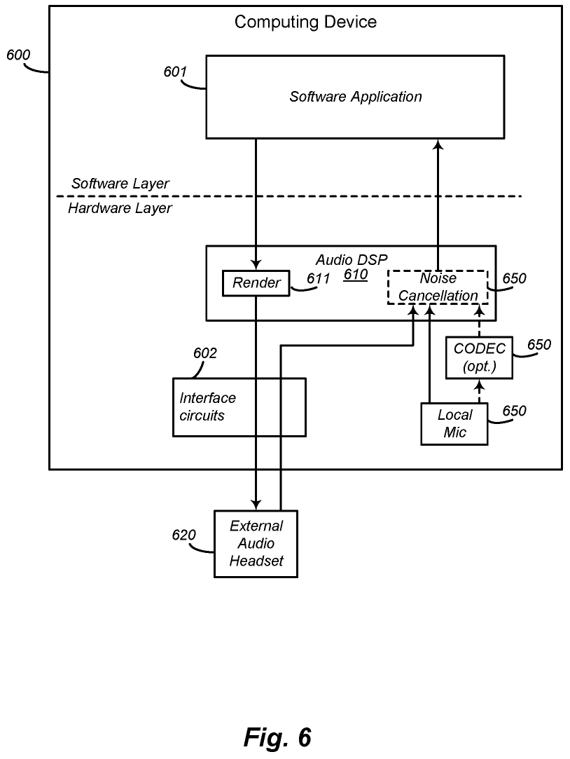

FIG. 6 illustrates hardware and software for performing audio processing according to an embodiment. In this example, noise cancellation 650 is implemented in DSP 610. An external headset 620 detects audio sends an audio signal to DSP 610 (e.g., via interface circuits 602, such as Bluetooth or USB), and a local microphone (e.g., on a notebook) detects the same audio and sends the audio signal to DSP 610. DSP 610 performs noise cancellation 650. The audio signal, with noise canceled, may be sent to a software application (e.g., Skype, WebEx, WhatsApp, etc . . . ), which may send the noise canceled audio signal to a recipient. As shown in this example, the noise canceled audio signal is sent to the external headset 620 via a rendering component 611 and interface circuits 602.

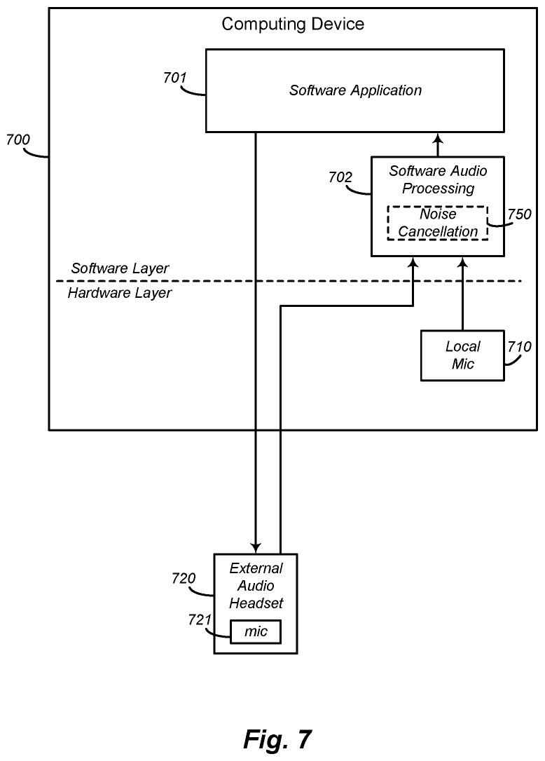

FIG. 7 illustrates hardware and software for performing audio processing according to another embodiment. Hardware circuits shown in previous figures are omitted here for clarity and illustrative purposes. In this example, the audio processing function is performed in software on a CPU or a neural network processor, for example. In this example, local mic 710 and an external mic 721 in audio headset 720 are received in a software layer of computing device 700. Noise cancellation 750 may be performed by an audio processing software, such as one or more software audio processing objects executing on a CPU or NN processor, for example. The noise canceled audio signal is sent to a software application, which may forward the audio (e.g., digitally) to a recipient across a network or to the external audio headset 720 (or both).

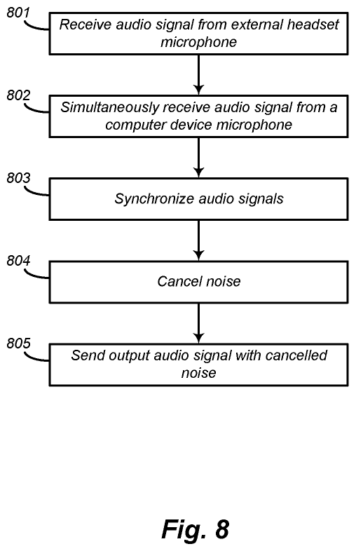

FIG. 8 illustrates an example method for performing audio processing according to another embodiment. At 801, an audio signal is received from an external headset microphone. At 802, the audio signal is simultaneously received from a microphone on a computing device. At 803, the audio signals are synchronized (e.g., by the computing device). At 804, the two audio signals are used to cancel noise and produce a single noise canceled audio signal. At 805, the noise canceled audio signal is output to one or more users.

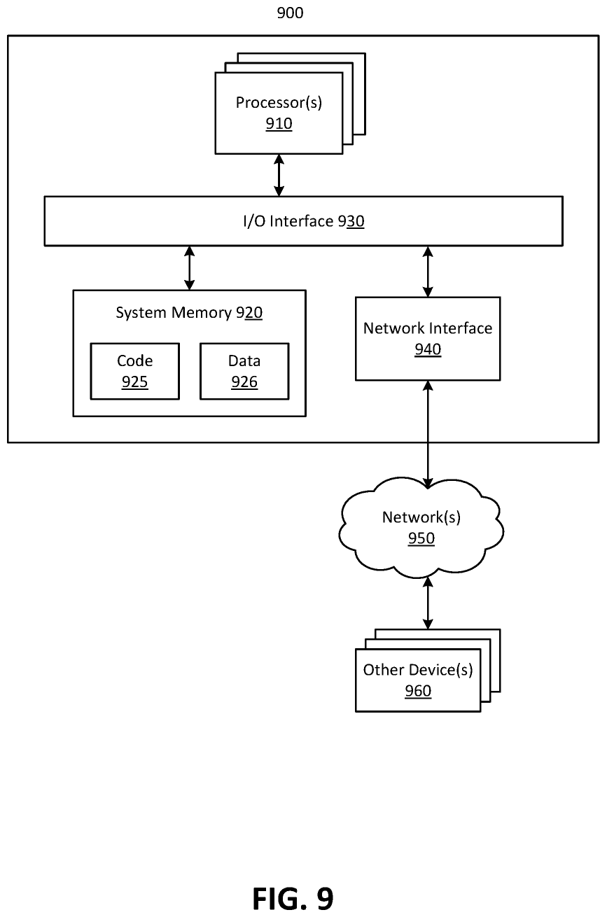

FIG. 9 and the following discussion are intended to provide a brief general description of a suitable computing environment in which the methods and systems disclosed herein and/or portions thereof may be implemented. Although not required, the methods and systems disclosed herein are described in the general context of computer-executable instructions, such as program modules, being executed by a computing device. Generally, program modules include routines, programs, objects, components, data structures and the like that perform particular tasks or implement particular abstract data types. The methods and systems disclosed herein may also be practiced in distributed computing environments where program modules may be located in both local and remote memory storage devices.

In describing various examples of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose. The specific features, acts, and mediums are disclosed as example forms of implementing the claims.

In at least some embodiments, a computing device 900 that implements a portion or all of one or more of the technologies described herein, including the techniques to implement the functionality described above, may include one or more processors 910 (e.g., CPUs, DSPs, NN processors) configured to access one or more computer or machine readable media (e.g., memory 920). FIG. 9 illustrates such a general-purpose computing device 900. In the illustrated embodiment, computing device 900 includes one or more processors 910 coupled to a system memory 920 via an input/output (I/O) interface 930. Computing device 900 further includes a network interface 940 coupled to I/O interface 930.

In various embodiments, computing device 900 may be a uniprocessor system including one processor 910 or a multiprocessor system including several processors 910 (e.g., two, four, eight, or another suitable number). Processors 910 may be any suitable processors capable of executing instructions. For example, in various embodiments, processors 910 may be general-purpose or embedded processors implementing any of a variety of instruction set architectures (ISAs), such as an x86 central processing unit (CPU) and/or various graphics processors (GPUs), or ARM based processors or any other suitable ISA. In multiprocessor systems, each of processors 910 may commonly, but not necessarily, implement the same ISA, while in other embodiments combinations of different processors may be used (e.g., CPUs and GPUs). Processors 910 may further be embodied as one or more microcontrollers, for example.

System memory 920 may be configured to store instructions and data accessible by processor(s) 910. In various embodiments, system memory 920 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 920 as code 925 and data 926.

In one embodiment, I/O interface 930 may be configured to coordinate I/O traffic between processor 910, system memory 920, and any devices, including network interface 940 or other peripheral interfaces. In some embodiments, I/O interface 930 may perform any necessary protocol, timing, or other data transformations to convert data signals from one component (e.g., system memory 920) into a format suitable for use by another component (e.g., processor 910). In some embodiments, I/O interface 930 may include support for devices attached through various types of peripheral buses, such as a variant of the Peripheral Component Interconnect (PCI) bus standard or the Universal Serial Bus (USB) standard, for example. In some embodiments, the function of I/O interface 930 may be split into two or more separate components, such as a north bridge and a south bridge, for example. Also, in some embodiments some or all of the functionality of I/O interface 930, such as an interface to system memory 920, may be incorporated directly into processor 910.

Network interface 940 may be configured to allow data to be exchanged between computing device 900 and other device or devices 960 attached to a network or network(s) 950, for example. In various embodiments, network interface 940 may support communication via any suitable wired or wireless general data networks, such as types of Ethernet networks, for example. Additionally, network interface 940 may support communication via telecommunications/telephony networks such as analog voice networks or digital fiber communications networks, via storage area networks such as Fiber Channel SANs or via any other suitable type of network and/or protocol.

In some embodiments, system memory 920 may be one embodiment of a computer-accessible medium configured to store program instructions and data as described above for implementing embodiments of the corresponding methods and systems. However, in other embodiments, program instructions and/or data may be received, sent or stored upon different types of computer-accessible media. Generally speaking, a computer-accessible medium may include non-transitory storage media or memory media, such as magnetic or optical media, e.g., disk or DVD/CD coupled to computing device 900 via I/O interface 930. A non-transitory computer-accessible storage medium may also include any volatile or non-volatile media, such as RAM (e.g. SDRAM, DDR SDRAM, RDRAM, SRAM, etc.), ROM, FLASH, etc., that may be included in some embodiments of computing device 900 as system memory 920 or another type of memory. Portions or all of multiple computing devices, such as those illustrated in FIG. 9, may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices. For purposes of this specification and the claims, the phrase “computer-readable storage medium” and variations thereof, does not include waves, signals, and/or other transitory and/or intangible communication media.

The various features and processes described above may be used independently of one another or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

### Additional Examples

Each of the following non-limiting examples may stand on its own, or may be combined in various permutations or combinations with one or more of the other examples.

Example 1 is a computing device comprising: one or more processors; a non-transitory machine-readable medium storing a program executable by the one or more processors, the program comprising sets of instructions for: receiving an audio signal from a microphone on the computing device; receiving the audio signal from an external device coupled to the computing device; and cancelling, by the computing device, noise in the audio signal.

Example 2 is the subject matter of Example 1 further comprising, after said cancelling, sending the audio signal from the computing device to the external device.

Example 3 is the subject matter of any one or more of Examples 1-2 wherein the external device comprises a directional microphone.

Example 4 is the subject matter of any one or more of Examples 1-3 wherein the computing device comprises an omnidirectional microphone.

Example 5 is the subject matter of any one or more of Examples 1-4 wherein the external device is a headset.

Example 6 is the subject matter of any one or more of Examples 1-5 wherein the external device is coupled to the computing device over a wireless connection.

Example 7 is the subject matter of any one or more of Examples 1-6 wherein the wireless connection is Bluetooth.

Example 8 is the subject matter of any one or more of Examples 1-5 wherein the external device is coupled to the computing device over a wired connection.

Example 9 is the subject matter of any one or more of Examples 1-5 wherein the wired connection is a Universal Serial Bus (USB).

Example 10 is the subject matter of any one or more of Examples 1-9 wherein the computing device is one of: a notebook computer, a tablet computer, or a mobile communications computer.

Example 11 is the subject matter of any one or more of Examples 1-10 wherein the program is executable by a first processor of the one or more processors, and wherein the first processor is a digital signal processor.

Example 12 is the subject matter of any one or more of Examples 1-10 wherein the program is executable by a first processor of the one or more processors, and wherein the first processor is a central processing unit.

Example 13 is the subject matter of any one or more of Examples 1-10 wherein the program is executable by a first processor of the one or more processors, and wherein the first processor is a neural network processor.

Example 14 is the subject matter of any one or more of Examples 1-13 further comprising synchronizing the audio signal from the microphone on the computing device and the audio signal from the external device.

Example 15 is the subject matter of any one or more of Examples 1-14 wherein the audio signal from the microphone and the audio signal from the external device are received simultaneously and comprise the substantially same ambient noise.

Example 16 is an apparatus for cancelling noise in an audio system, the apparatus comprising: a microphone configured to produce an audio signal; a first external input configured to receive audio signal from an external device coupled to the computing device; means for cancelling noise in the audio signal to produce a noise cancelled signal, wherein the noise cancelled signal is sent from the computing device to the external device.

Example 17 is the subject matter of Example 16 wherein said means for cancelling noise in the audio signal is a digital signal processor circuit.

Example 18 is the subject matter of Example 16 wherein said means for cancelling noise in the audio signal is a central processing unit.

Example 19 is the subject matter of Example 16 wherein said means for cancelling noise in the audio signal is a neural network processor.

Example 20 is a method for cancelling noise in an audio system, the method comprising: receiving an audio signal from a microphone on a computing device; receiving the audio signal from a headset coupled to the computing device; cancelling, by the computing device, noise in the audio signal; and sending the audio signal. In various additional examples the method may include any one or more of the features of Examples 1-19.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A computing device comprising:
one or more processors;
a non-transitory machine-readable medium storing a program executable by the one or more processors, the program comprising sets of instructions for:
receiving an audio signal from a microphone on the computing device;
receiving the audio signal from an external device coupled to the computing device; and
cancelling, by the computing device, noise in the audio signal.

2. The computing device of claim 1, further comprising synchronizing the audio signal from the microphone on the computing device and the audio signal from the external device.

3. The computing device of claim 1, wherein the audio signal from the microphone and the audio signal from the external device are received simultaneously and comprise the substantially same ambient noise.

4. The computing device of claim 1, further comprising, after said cancelling, sending the audio signal from the computing device to the external device.

5. The computing device of claim 1, wherein the external device comprises a directional microphone.

6. The computing device of claim 1, wherein the computing device comprises an omnidirectional microphone.

7. The computing device of claim 1, wherein the external device is a headset.

8. The computing device of claim 1, wherein the external device is coupled to the computing device over a wireless connection.

9. The computing device of claim 8, wherein the wireless connection is Bluetooth.

10. The computing device of claim 1, wherein the external device is coupled to the computing device over a wired connection.

11. The computing device of claim 10, wherein the wired connection is a Universal Serial Bus (USB).

12. The computing device of claim 1, wherein the computing device is one of: a notebook computer, a tablet computer, or a mobile communications computer.

13. The computing device of claim 1, wherein the program is executable by a first processor of the one or more processors, and wherein the first processor is a digital signal processor.

14. The computing device of claim 1, wherein the program is executable by a first processor of the one or more processors, and wherein the first processor is a central processing unit.

15. The computing device of claim 1, wherein the program is executable by a first processor of the one or more processors, and wherein the first processor is a neural network processor.

16. An apparatus for cancelling noise in an audio system, the apparatus comprising:
a microphone configured to produce an audio signal;
a first external input configured to receive audio signal from an external device coupled to the computing device;
means for cancelling noise in the audio signal to produce a noise cancelled signal,
wherein the noise cancelled signal is sent from the computing device to the external device.

17. The apparatus of claim 16, wherein said means for cancelling noise in the audio signal is a digital signal processor circuit.

18. The apparatus of claim 16, wherein said means for cancelling noise in the audio signal is a central processing unit.

19. The apparatus of claim 16, wherein said means for cancelling noise in the audio signal is a neural network processor.

20. A method for cancelling noise in an audio system, the method comprising:
receiving an audio signal from a microphone on a computing device;
receiving the audio signal from a headset coupled to the computing device;
cancelling, by the computing device, noise in the audio signal; and
sending the audio signal.
